(19) United States
(12) Patent Application Publication
(10) Pub. No.: US 2008/0264029 A1
(43) Pub. Date: Oct. 30, 2008

(54) Biodegradable grass and debris catcher

(76) Inventor: Stephen Vogt Sepaniak, Bernardsville, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 11/796,917

(22) Filed: Apr. 30, 2007

(51) Int. Cl. A01D 43/063

(52) U.S. Cl. 56/202

(57) ABSTRACT

A biodegradable grass and debris catcher is attached to an exit chute of a lawn mower and garden vacuum/blower discharge chute to collect grass clippings and debris. The biodegradable grass and debris collector bag, containing grass clipping and debris, is composted or disposed of in a landfill without incorporating polymeric residue. The biodegradable grass and debris catcher has a plurality of layers, preferably three layers, of industrial strength paper. A plurality of air vent holes on side walls of the bag release discharged air while trapping grass clippings or debris. The industrial strength paper may be reinforced with biodegradable cotton fibers.

### BACKGROUND OF THE INVENTION

1. Field of the Invention

The present invention relates to grass catching apparatus for disposal of lawn and garden debris; and, more particularly, to a disposable biodegradable bag that fits on a mower or garden vacuum, collects grass or garden debris and is thereafter composted or discarded to a landfill without the inclusion of non-degradable polymeric residue.

2. Description of the Prior Art

Numerous patents address issues related to grass catchers and means for attaching grass catchers to lawn mowing equipment. The collected grass clippings have to be removed from the grass catcher and placed in separate garbage bags for disposal, so that the grass catcher can be subsequently reused. Grass clippings are generally packaged in plastic garbage bags, which are not biodegradable in a landfill. Even so-called biodegradable plastic bags have cellulose or starch thereto. Environmental action of the cellulose or starch degrades the plastic product to produce smaller segments of the polymeric bag; but the plastic or polymeric content of the bag remains substantially unchanged.

U.S. Pat. No. 4,186,546 to Machado et al. discloses a disposable bag mounting for a lawn mower. The lawn mower has an upward chute, which delivers glass clippings. A polyurethane bag is attached to the chute, and vent holes are provided in the bag for escape of air. The bag used is made from polyethylene, which is not biodegradable.

U.S. Pat. No. 4,345,418 to Arizpe discloses a disposable bag mounting and shutdown mechanism for a rotary lawn mower. The grass catcher support, which is pivoted, carries a dacron of nylon bag. Tilting the grass catcher support engages a lever that shuts down the engine and applies a brake mechanism. The grass catcher bag is not biodegradable since it is made from dacron or nylon.

U.S. Pat. No. 4,377,063 to Leaphart discloses a disposable grass catcher. The grass catcher is attached to a standard lawn mower and is provided with shields to prevent high velocity projectiles from reaching the user or bystanders. The bag for the grass catcher is made from polypropylene or other suitable material and therefore is not biodegradable.

U.S. Pat. No. 4,505,095 to Short discloses hoop adapter assembly for a powered lawn mower. The hoop adapter assembly is adapted to be easily attached to a lawn mower about an exit opening of a discharge duct to facilitate fitting a disposable trash bag on the hoop adapter of the assembly for picking up leaves. The hoop adapter is oval in shape and is held to the frame or housing portion by wire ties or shock cords and the disposable bag is held to the hoop adapter by pinch clamps. The spaces between the discharge duct and the hoop adapter provide exit vents for the air that flows from the undercarriage of the lawn mower carrying leaves and debris into the bag. The hoop assembly attaches a grass catcher bag to the exit chute of a lawn mover. The grass collection disposable trash bag is not disclosed as being biodegradable.

U.S. Pat. No. 4,566,257 to Akrabawi discloses a lawn mower disposable grass collection bag attachment. A disposable plastic bag catches the grass clippings. The bag is attached to a transfer plate and is positioned in close proximity with the exit chute of the lawn mower. The disposable plastic bag is placed within a safety canvas bag shield. The plastic disposable bag that catches grass clippings is not biodegradable.

U.S. Pat. No. 4,747,259 to Kline et al. discloses a grass catching assembly and disposable bag therefore. The grass catching assembly uses disposable bags so that the grass clippings may not have to be transferred from a reusable container. The bags used may be in the form of a roll or individual bags carried by the lawn mower. The bags are made from polyethylene, a common refuse bag material, and are not biodegradable.

U.S. Pat. No. 4,848,070 to Berglund discloses a grass catching apparatus for a mower. The grass catcher is made from plastic. It receives grass clippings and air from the lawn mower. The air and escaped grass clippings are discharged from a second chute that throws the air and escaped grass clippings in front of the lawn mower. The grass catcher bag is not biodegradable, since it is made from plastic.

U.S. Pat. No. 4,907,403 to Jones discloses a grass mower improvement. The grass mower improvement comprises a sling attachment that carries a plastic bag. The grass clippings and air from the mower are delivered to a housing attached to the handle. Grass clippings fall into the plastic bag due to its weight, while air, which is lighter, escapes through the housing. The grass catcher bag is made from plastic; and hence is not biodegradable.

U.S. Pat. No. 4,989,400 to Wark discloses a disposable bag and mounting apparatus for a lawn mower. The disposable bag is adapted to collect grass clippings or the like. It has ventilation holes in only a portion of its surface. The bag has a narrow mouth mounted to a connector assembly or, alternatively, directly to a discharge chute of a mower. The disposable bag is supported by a cradle assembly mounted to the handlebars of the mower. The disposable bag is a plastic sheet material on the order of two mils in thickness. A cradle supports the plastic disposal bag with a plurality of apertures for venting air delivered by the lawn mower. The bag used for collecting grass clippings is a plastic bag and is not biodegradable.

U.S. Pat. No. 5,003,758 to Bernstein discloses a disposable debris bag for lawnmowers and sweepers. A disposable biodegradable debris collection bag of thin walled flexible plastic has a neck with a collar to slide onto a discharge boot of a debris discharging machine. The bag is characterized by primary and secondary securement means of twist-tie form independently operable to constrict the collar onto the boot and to close the bag for removal. The walls of the bag are composed of biodegradable material and preferably of a disintegratable homoplastic material, or one relating to or derived from another species, wherein there is a similarity of form with a different fundamental structure, and wherein there is a superficial resemblance. It is this type of plastic that is used herein; for example plastic comprised of as little as 5% starch mixed with as much as 95% polyurethane, or preferably “Novon” a trademark, a bio-plastic starch as manufactured by Warner-Lambert. The disposable bag is of pliable and supple biodegradable material with at least one panel of biodegradable porous filter material for the discharge of air pressure while retaining fine dust and debris discharged. This is a disposal debris bag made from a plastic such 95% polyurethane with 5% starch so that the plastic is biodegradable. Upon degradation, the biodegraded product disintegrates; but 95% of the plastic remains without degradation. The biodegradation occurs by the dissolution of starch portions of the plastic bag and the bag does not show up in a landfill, but the plastic portions still remain without biodegradation. Accordingly, biodegradation of the plastic bag is strictly cosmetic.

U.S. Pat. No. 5,042,241 to Boylston et al. discloses a grass catcher assembly and method. A walk-behind mower is provided with a disposable grass-collecting bag attached to the discharge chute. The bag is received in a grass collector having one end mounted to the mower handlebars and another end mounted to the discharge chute over the disposable bag. The collector mounting to the chute also secures the bag on the chute. After the bag is mounted about the chute, the body of the bag is folded and placed into the chute. The collector is then mounted to the mower with its inlet about the chute. When the lawn mower is started, the airflow through the chute will expel the bag into the collector and then inflate the bag in the collector to be ready to receive grass clippings. The bag used is made from cotton or nylon and is not made from a biodegradable material. The bag only collects the grass clippings. It is not disposed of; but rather is used over and over again. This grass clipping collection device does not therefore disclose a disposable biodegradable bag.

U.S. Pat. No. 5,178,469 to Collinson discloses a biodegradable container for liquid-containing solid materials. This collapsible biodegradable container, or bag, is for holding liquid-containing solid materials, e.g., compostible materials, such as food waste, yard waste, and the like, from restaurants, homes, etc. A single sheet of two-ply material is used to form both the bag side walls and the bag bottom wall. Kraft paper is used to form the bag outer surface, whereas a cellulose film, or cellophane, is used to form the bag inner surface. A slab of moisture-absorbent material is also placed on the bag bottom wall, to intercept liquid draining from the contained material toward the bag bottom wall. The outer paper ply gives the bag its structural strength, so that it can be self-sustaining in an upright condition. The inner cellulose layer, or cellophane ply, provides a liquid barrier to protect the outer paper ply from the destructive effects of liquid. The bag, is also permeable to air and water vapor, while retaining liquids. This is a two-ply construction container with an outer layer of Kraft paper, which provides structural strength with an inner layer of cellophane sheet, which provides moisture barrier properties. This container for liquids and solids is biodegradable, since cellophane and cellulose articles biodegrade in time. The container is not a biodegradable disposable grass catcher bag for receiving grass clippings. It is not attached to a lawn mower. There are no holes provided to vent the air delivered by the lawn mower.

U.S. Pat. No. 5,179,824 to Ridge et al. discloses a disposable grass catcher. The grass catcher is provided for a lawn mower having a housing with a grass discharge area, and a U-shaped handle. The grass catcher consists of an adapter having a flange at one end and another end attachable to the grass discharge area of the housing. A disposable bag has a mouth mountable to the flange of the adapter so that the bag can catch cut grass traveling through the grass discharge area of the housing. A mechanism is provided for supporting the disposable bag from the handle of the lawn mower so that the disposable bag will not drag on the ground surface when a person is operating the lawn mower. This disposable grass catcher is attached to the grass clippings exit chute of a lawn mower. The disposable grass catcher is supported by plurality of support rods. The disposable grass catcher is not indicated to be biodegradable.

U.S. Pat. No. 5,243,809 to Redding discloses a leaf and lawn debris high-efficiency disposable bag with support. This is an apparatus for containing leaf and lawn debris as an accessory to a power mower. It comprises a bag made from plastic film and plastic mesh with coupled seals, means for expelling air from said bag as it fills with the debris, an attached enclosure made from large mesh material, means for placing bag into enclosure, and means for sealing the filled bag. All plastic is indicated to be biodegradable and has a thickness of approximately 1-4 mil. The '809 patent does not specify any biodegradable plastic film for the disposable bag. The patent states, “The actual determination of what is biodegradable plastic is uncertain, but if identified by the manufacture as such in advertising and on the package, then it is assumed meet appropriate standards, and these are adequate for the subject invention. In an alternate formulation plastic that is not biodegradable is employed; however, with the alternate embodiment, the debris material is normally just stored waiting further use or transfer’”]as an alternate non-biodegradable plastic bag is used and the grass clippings are transferred rather than the disposable bag disposed.

U.S. Pat. No. 5,365,727 to Cross discloses a grass-bagging apparatus. The grass-bagging apparatus is adapted for use with a lawn mower. The apparatus includes a chute with a disposable bag disposed therearound. An attaching frame is used to fasten the chute to the mower and retain the bag thereon. Grass and other cuttings discharged from the lawn mower are directed in the bag through the chute. After the bag is filled, the chute may be removed from the bag while leaving the cuttings in the bag. The filled bag may then be closed for disposal and a new bag positioned on the chute. A protective screen may be provided between the plastic bag and the operator in the event that objects discharged from the mower penetrate the material of the bag. The bag is made from a flexible plastic material with a plurality of perforations. This is a plastic disposable bag with perforations for venting the air delivered by the lawn mower while the grass bagging apparatus retains the grass clippings. The plastic bag is not biodegradable.

U.S. Pat. No. 5,564,265 to Pitt discloses a grass catcher insert and adapter for lawn mowers. The grass catcher insert is connected to an adaptor and fits within an existing grass catcher in a lawn mower. The grass catcher bag is made from non-woven fabric material. It merely facilitates the removal of clumped grass clippings, which may be present in a lawn mower grass catcher; instead, the user pulls out the insert. The grass catcher insert is not disposed. It is not made from biodegradable material.

U.S. Pat. No. 5,673,544 to Voigt discloses a disposable lawn mower debris bag system. The disposable bags are taken out one at a time from a roll and attached to the discharge chute of a lawn mower. The disposal bags are fabricated out of a thin flexible plastic material, paper material, or a combination of plastic and paper material with a plurality of small holes to vent air produced by the operation of the power lawn mower. The disposable bags contain plastic and therefore are not biodegradable.

U.S. Pat. No. 5,679,421 to Brinton discloses biodegradable bags and processes for making such biodegradable bags. The biodegradable bag is a two-ply structure with a layer of Kraft paper thermally bonded to a thermoplastic polymer sheet. The thermoplastic sheet is selected from any one, or combinations of, polyvinyl alcohol, hydroxyethylcellulose polymer, polyethylene glycol polymer, polycaprolactone, polylactic acid, hydroxybutyrate polymer, hydroxyvalerate polymer, and a copolymer of hydroxybutyrate and hydroxyvalerate. The thermoplastic polymer takes a long time to degrade as compared to Kraft paper. The biodegradable bags are not used as a grass catcher bag. The thin layer of thermoplastic polymer together with a single layer of Kraft paper is unlikely to have strength sufficient to function as a grass catcher bag. There are no air vent holes provided in the two-ply bag.

U.S. Pat. No. 6,151,875 to Collins discloses a grass catcher insert for a lawn mower. The insert is fitted within a grass catcher bag of a lawn mower to collect the grass clippings. One of the faces of the insert is provided with air vent holes to discharge the air from the lawn mower discharge chute. Upon the grass clippings reaching the capacity of the insert, the user may slide the insert from the grass catching bag and place said insert in the governmental approved location for disposal. No contact with the grass clippings, or secondary container for the grass clippings is required. Time, effort and money are all thereby saved. The insert bag is not made from biodegradable material.

U.S. Pat. No. 6,810,651 to Washington discloses a yard waste collection bag. The yard waste collection bag is a two-ply construction. It comprises an outer layer of paper with an inner layer of a biodegradable polymeric layer, which inhibits tearing of the paper bag and moisture migration. The biodegradable polymeric layer is not specified in the '651 patent disclosure. There are no air vents provided. Consequently, the bag will likely rupture when connected to a lawn mower.

U.S. Pat. No. 6,860,094 to Abrams discloses a rigid liner for a refuse bag. The rigid liner fits inside a refuse bag and keeps the refuse bag open. When the refuse bag is full, the rigid liner is removed. The refuse may be compacted when the rigid liner is in place. The refuse bag may be made from burlap which is biodegradable or may be made from plastic which is not biodegradable. The rigid insert is not a biodegradable component, but is a refuse filling device that keeps the refuse bag open during refuse fill. This liner is not a grass catching bag, but an insert for an open grass collection bag.

U.S. Published Patent Application No. 2005/0025397 to Zhao discloses a disposable bag with high air permeability. The disposable bag is comprised of at least one layer of air permeable and flexible thin material at each portion of the bag. The air permeability of some portions of the bag is in the range of 300 ft3/ft2/min to 1500 ft3/ft2/min. The lawn debris, leaves, and particulate matters are blown into the disposable bag by a powered machine. The bag provides a convenient means of effective collection of the debris, leaves, and particulate matters with easy air ventilation. The disposable bag material is fibrous nonwoven material reinforced with a woven screen or an extruded net or a polymeric film, regionally perforated with holes, linear slits, biaxial slits, or the combinations, so that the perforated and the non-perforated areas form a grid-like pattern. The disposal bag is made of a flexible thin material, such as nonwoven fabrics, polymeric film, paper, net, screen or their combinations. These materials, except for the paper, are not biodegradable. The paper is weakened significantly when air permeability slits are provided.

Internet publication “Biodegradable Plastic Bags” at http://www.biogroupusa.com/gardening-weed-block.html discloses BioBag Lawn & Leaf bags which are a full 33 gallon capacity, measuring 32.5 inches wide and 39 inches tall. The Lawn & Leaf bags are durable and sturdy enough to handle the toughest yard jobs. They even come with a removable tear-strip at the top of each bag for easy tying. Internet publication “Biobag Facts” at http://www.biogroupusa.com/biodegradable-bags.html discloses BioBag Facts. The biobag is a biodegradable corn product and will degrade in 12 days. This bag has a large amount of stretch and therefore is unsuited for being attached to a lawn mower, where debris and air are propelled at a high velocity. The bag does not have air vents to discharge the air that is exhausted by the lawn mower chute.

There remains a need in the art for a biodegradable grass catcher that effectively collects grass clippings from the chute of a lawn mower while successfully venting the air delivered by the lawn mower. It would be advantageous if a biodegradable grass catcher, containing grass clippings could be directly composted without having to discharge the grass clippings or leave them at curbside for disposal. It would also be advantageous if the biodegradable grass clippings delivered by the bag could degrade completely in a landfill without increasing plastic loading at the landfill site.

### SUMMARY OF THE INVENTION

The present invention provides a disposable biodegradable bag appointed to fit on a mower device or a garden vacuum and to act as a grass or debris catcher thereon. The biodegradable grass or debris catcher bag comprises a plurality on industrial grade paper bags provided with a plurality of air venting holes. Use of this plurality of paper bags prevents tearing of the bag at the air vent hole locations. Moreover, if the grass or debris is wet the plurality of paper bags does not lose mechanical integrity. At best, the innermost bag loses strength, but the outer plurality of bags provides the needed mechanical support. In a preferred embodiment, the biodegradable grass and debris catcher bag comprises three layers of industrial grade paper.

The grass and debris catcher effectively catches and collects nearly all the grass clippings; and does not require that the grass clippings be emptied into a plastic bag for disposal. The biodegradable grass and debris catcher is either discarded directly or placed in a compost bin to degrade the grass clippings and the bag into high quality compost. Due to the biodegradable properties of the grass and debris catcher, its use advantageously prevents deposit of undesirable materials, such as non-biodegradable polymers and the like, within a compost pile or a landfill.

The biodegradable grass and debris catcher comprises a disposable bag that readily fits onto typical debris chutes associated with lawn machines. Such lawn machines include lawn mowers of the riding and push variety, as well as leaf blower/vacuum machines and the like. The biodegradable grass and debris catcher's disposable bag securely attaches to the debris chute of the lawn machine or garden vacuums/blowers in a secure manner so that the disposable bag does not become disengaged from the debris chute. The disposable bag of the biodegradable grass or debris catcher is composed of a biodegradable material, such as heavy-duty industrial strength paper, and is readily discarded after it is full. The thickness of this heavy-duty paper is typically in the range of 0.003 inches to 0.008 inches. The biodegradable grass and debris catcher is provided with a plurality of air vent holes to discharge air delivered by the lawn mower or leaf blower/vacuum while collecting grass clippings or leaf debris. Typically, the diameter of these air vent holes is in the range of 0.05 inch to 0.25 inch. The biodegradable material provides an environmentally friendly means for eliminating the debris waste. The disposable nature of the biodegradable grass and debris catcher bag enables the user to simply discard the grass catcher when it is filled with debris. A new disposable grass and debris catcher bag can then be readily placed on the debris chute for the next mowing or leaf blowing/vacuum event. As a result, the user avoids the cumbersome task of emptying the grass catcher, and hence the exposure to large amounts of dust and pollen that are oftentimes released during the bag-emptying step. Advantageously, with use of the biodegradable grass catcher, the operator simply removes the disposable bag and discards it in its entirety without coming into contact with the dust and debris therein.

Generally stated, The biodegradable grass and debris catcher broadly comprises: (i) a disposable bag composed of a biodegradable material; (ii) said disposable bag comprising top, bottom, and side walls, and having an interior compartment and an exterior surface; (iii) the disposable bag including apertures for venting air; (iv) the top wall of the disposable bag further comprising a securing means having an aperture therein, the securing means being adapted to removably attach the disposable bag to a debris chute of a lawn or garden device so that debris from the debris chute traverses through the aperture and are received into said interior compartment of said disposable bag; and (v) the top wall of the disposable bag further comprises sealing means adapted to close the aperture of the disposable bag when the disposable bag is filled with the debris and the securing means is disengaged from the debris chute of the lawn device, so that the disposable bag is removed from the lawn device and is discarded.

Key features associated with the shop vacuum and compressor system include, in combination, the means set forth below:
1. A grass and debris catcher bag composed of a plurality of layers, preferably three layers of heavy duty paper, each of which layers is biodegradable;
2. The grass and debris catcher bag having a plurality of side walls defining an inner compartment for receiving an air stream containing grass debris discharged by the lawn mower;
3. Each of the side walls of the grass and debris catcher bag having a plurality of apertures therein for venting air delivered by the lawn mower without allowing escape of grass clippings entrained within the air stream;
4. The grass and debris catcher bag having a top portion and a bottom portion;
5. The top portion having an aperture therein for receiving an exit chute of a lawn or garden machine;
6. Securing means for firmly attaching the top portion to the exit chute so that the chute is retained within the aperture during operation of the lawn or garden machine;
7. Closure means for closing the aperture when the biodegradable grass and debris catcher has been filled with grass clippings and the lawn mower exit chute is removed therefrom; and
8. The closed biodegradable grass and debris catcher bag containing grass clippings or debris being disposed of to a compost pile without addition of non-biodegradable materials, such as plastic products.

### BRIEF DESCRIPTION OF THE DRAWINGS

The invention will be more fully understood and further advantages will become apparent when reference is had to the following detailed description of the preferred embodiments of the invention and the accompanying drawing, in which:

FIG. 1a is a schematic top view depicting the biodegradable grass and debris catcher;

FIG. 1b is a schematic side view depicting the biodegradable grass and debris catcher;

FIG. 2 is a schematic view depicting the biodegradable grass and debris catcher attached to a riding lawn device;

FIG. 3 is a schematic view depicting the biodegradable grass and debris catcher attached to a push lawn device;

### DETAILED DESCRIPTION OF THE INVENTION

The present invention provides a biodegradable grass and debris catcher bag that is readily attached to variety of machinery including push type lawn mower, riding lawn mower, leaf vacuum/blower equipment and the like. Because the grass and debris catcher bag is made from biodegradable material, the biodegradable grass and debris catcher bag together with grass clippings or collected debris may be disposed in a compost bin or curbside for landfill disposal without the user contacting grass clippings, collected debris dirt and other waste material included within the grass catcher bag, Since the biodegradable grass and debris catcher bag has no non biodegradable material the disposed bag with grass clippings or collected debris does not add polymeric material to the compost or landfill.

The biodegradable grass and debris catcher bag is provided with means of attachment of the biodegradable bag to the exit chute of a push type or riding lawn mower or garden vacuum/blower. This securing means typically includes a tightenable hose clamp that tightens the biodegradable grass and debris catcher bag that is slipped over the exit chute.

After the biodegradable bag is full with grass clippings or collected debris, the securing clamp is released and the biodegradable grass and debris catcher bag is slid out from the exit chute of the lawn mower. A sealing means such as string is provided to collapse the biodegradable grass and debris catcher bag opening previously connected to the lawn mower chute thereby securing the grass clippings from spillage.

The biodegradable grass and debris catcher bag is made from a plurality of layers of industrial strength paper. The high strength paper generally retains its strength even when the paper is made due to the incorporation of cotton fibers within the paper matrix. Generally, the percentage of cotton fibers ranges from about 5 to 50 percent by weight. Cotton fibers are also biodegradable and the incorporation of these strengthening elements does not take away its biodegradability. These cotton fibers also strengthen the area surrounding the air vents for exhausting the air delivered by the lawn mower or garden vacuum/blower, while still capturing the grass clippings or debris. Use of a plurality of industrial strength paper layers in the walls of the biodegradable grass catcher bag ensures that the integrity of the bag is maintained even when mowing wet grass or handling wet debris. The wetness at best reduces the strength of inner industrial strength layer of the biodegradable grass and debris catcher bag. Moreover, the presence of moisture in the grass clippings or collected debris advantageously accelerates the biodegradation process.

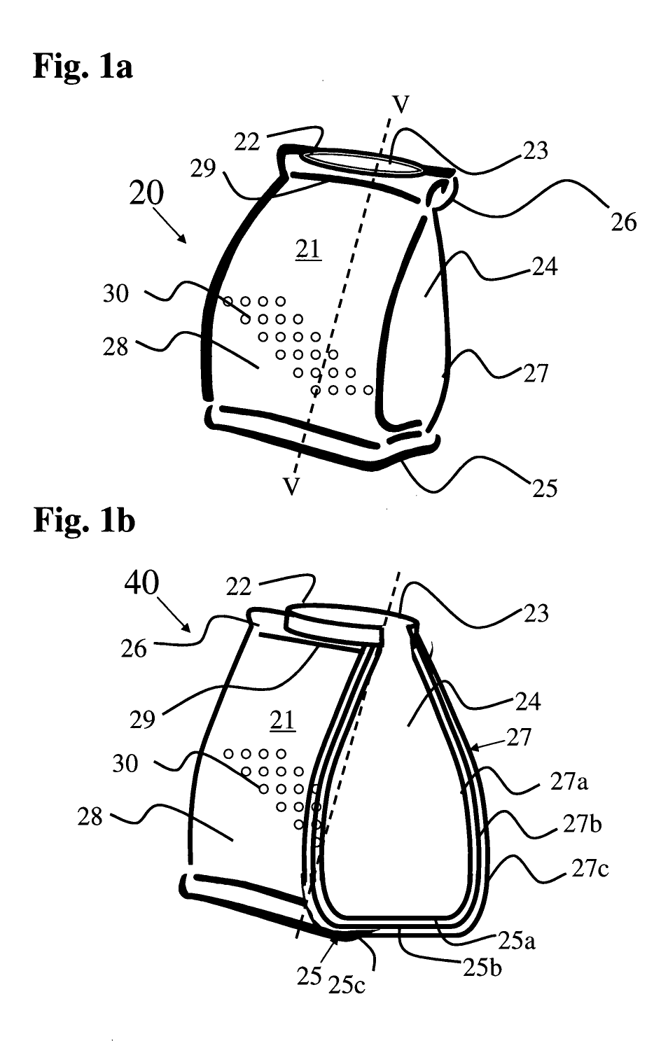

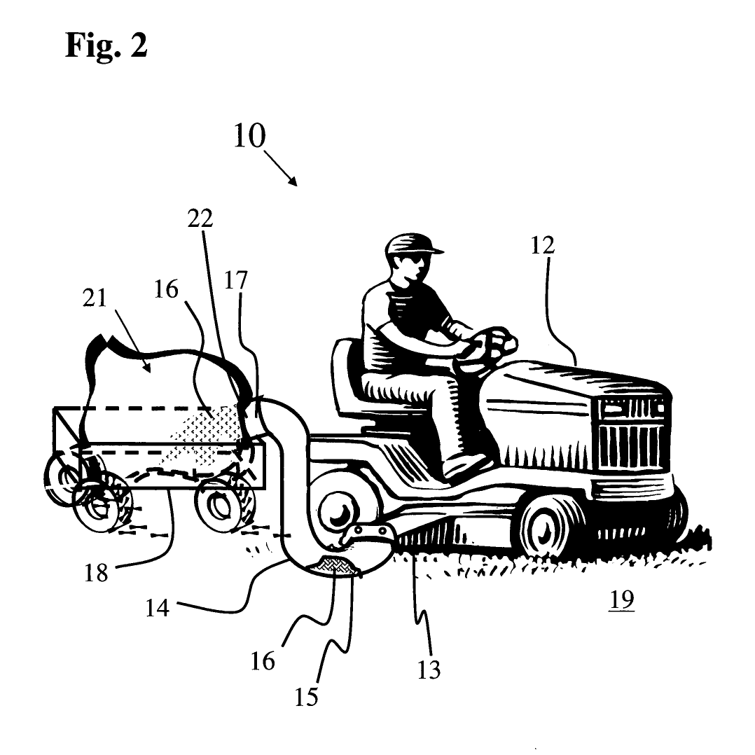

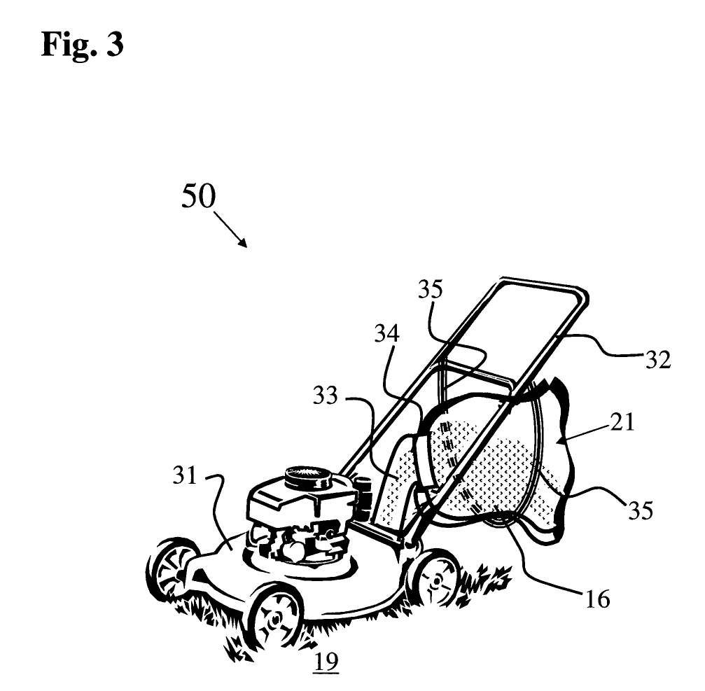

FIG. 1a illustrates a schematic view of the biodegradable grass and debris catcher, showing a top view shown generally at 20. The biodegradable grass and debris catcher comprises disposable bag 21 composed of a biodegradable material. The biodegradable grass and debris catcher bag has a plurality of apertures 30 for venting air delivered by the lawn mower along with grass clippings. The disposable bag has a top 26, bottom 25, and sidewalls 27. These portions are arranged to form an interior compartment 24 and an exterior surface 28. Top wall 26 of disposable bag 21 further comprises a securing means 22 having an aperture 23 integrally provided therein. The securing means 22 is adapted to removably attach disposable bag 21 to a debris chute of a lawn device (see reference numeral 14 of FIG. 2 and reference numeral 33 of FIG. 3, discussed hereinbelow). The top wall 26 of disposable bag 21 further comprises sealing means 29 appointed to close aperture 23 of disposable bag 21 when disposable bag 21 is filled with debris and is removed from the lawn device to be discarded.

FIG. 1b illustrates generally at 40 a side view of the biodegradable grass and debris catcher taken along line V of FIG. 1a. A disposable biodegradable grass and debris catcher bag 21 having top 26, bottom 25, and sidewalls 27, interior compartment 24 and exterior surface 28, is shown taken along line V. Securing means 22 and aperture 23 are also illustrated along with sealing means 29. Disposable bag 21 is composed of a biodegradable material, preferably industrial strength paper. Preferably, sidewalls 27 further comprise a three-ply layer arrangement, 27a, 27b, and 27c. In addition, preferably, bottom wall 25 further comprises the three-ply layer arrangement, 25a, 25b, and 25c. The three-ply layer arrangement of the biodegradable material, which is preferably composed of paper, provides a durable disposable bag. Such three-play layer arrangement substantially prevents penetration of or damage to disposable bag 21 potentially which might otherwise be caused by debris entering the bag at high velocity. The biodegradable grass and debris catcher bag has plurality of apertures 30 for venting air delivered by the lawn machine or garden vacuum/blower without allowing escape of lawn debris entrained within the air stream. Advantageously, the three-ply layer arrangement of bag 21 mitigates the risk of damage to bag 21 during handling by the operator or others involved in bag discarding activities.

FIG. 2 illustrates a schematic view of the biodegradable grass and debris catcher attached to a riding lawn device, shown generally at 10. Herein the disposable bag 21 of the biodegradable grass and debris catcher is attached to a debris chute 14 of a riding lawn mower 12 appointed to mow lawn 19. The riding lawn mower 12 includes a typical grass exhaust 13 attached to the debris chute 14. Disposable bag 21 typically rests in a wagon or cart 18 and is pulled along behind riding lawn mower 12. The disposable bag 21 of the biodegradable grass catcher is removably attached to debris chute 14 of riding lawn mower 12 by way of engagement between securing means 22 and chute end portion 17. Securing means 22 is adapted to removably attach disposable bag 21 to debris chute 14 so that debris 16 from debris chute 14 traverses through aperture 23 (shown in FIGS. 1a and 1b) and into disposable bag 21. A cutout portion of debris chute 14 is shown at 15, to illustrate the movement of debris 16 through debris chute 14. As illustrated, debris 16 entrained within an air stream passing through debris chute 14, is blown into disposable bag 21.

FIG. 3 is a schematic view illustrating the biodegradable grass and debris catcher attached to a push type lawn device, shown generally at 50. Herein the disposable bag 21 of the biodegradable grass and debris catcher is attached to a debris chute 33 of a push lawn mower or leaf collector or blower 31 adapted to mow/remove leaves from lawn 19. The push lawn mower 31 includes a typical grass/leaf/debris exhaust attached to the debris chute 33. Disposable bag 21 generally rests in a support 35 typically extending from a handle 32 of the push lawn mower 31. The disposable bag 21 of the biodegradable grass and debris catcher is removably attached to debris chute 33 by way of engagement between securing means 22, shown in FIG. 1a and FIG. 1b and chute end portion 34. Securing means 22 shown in FIG. 1a and FIG. 1b is adapted to removably attach disposable bag 21 to debris chute 33 so that grass and debris 16 from debris chute 33 traverse through aperture 23, shown in FIG. 1a and are received into disposable bag 21.

Having thus described the invention in rather full detail, it will be understood that such detail need not be strictly adhered to, but that additional changes and modifications may suggest themselves to one skilled in the art, all falling within the scope of the invention as defined by the subjoined claims.

1. A grass and debris catcher bag, comprising:
a. a biodegradable bag comprising;
1. a exterior surface defined by a plurality of side walls and a bottom wall;
2. an inner compartment contained within said plurality of side walls and said bottom wall;
3. said side walls having a plurality of apertures appointed to trap grass clippings and debris and discharge vent air from a lawn and garden vacuum machine;
4. said inner compartment having an aperture at the end distal to said bottom wall for attaching said biodegradable bag to said lawn and garden vacuum machine; and
5. a plurality of layers of biodegradable industrial strength paper comprising said side walls and said bottom wall of said inner compartment;
b. attachment means for securing said biodegradable bag to a debris exit chute of said lawn and garden vacuum machine;
c. a closure means for securing said aperture after said biodegradable bag is filled with grass clippings and debris;
whereby said biodegradable bag when filled with grass clippings is secured by said closure means and composted or disposed of in a landfill without incorporation of polymeric residue.

2. A grass and debris catcher bag as recited by claim 1, wherein said plurality of layers of industrial strength paper comprises three layers of industrial strength paper.

3. A grass and debris catcher bag as recited by claim 1, wherein said industrial strength paper has a thickness in the range of 0.003 inches to 0.008 inches.

4. A grass and debris catcher bag as recited by claim 1, wherein said industrial strength paper has cotton fibers.

5. A grass and debris catcher bag as recited by claim 4, wherein said cotton fibers are present in the range of 5 to 50% by weight.

6. A grass and debris catcher bag as recited by claim 1, wherein said side wall apertures have a diameter in the range of 0.05 inches to 0.25 inches.

7. A grass and debris catcher bag as recited by claim 1, wherein said lawn and garden vacuum machine is a riding lawn mower.

8. A grass and debris catcher bag as recited by claim 1, wherein said lawn and garden vacuum machine is a push type lawn mower.

9. A grass and debris catcher bag as recited by claim 1, wherein said lawn and garden vacuum machine is a garden vacuum.

10. A grass and debris catcher bag as recited by claim 1, wherein said lawn and garden vacuum machine is a garden blower.

11. A grass and debris catcher bag as recited by claim 1, wherein said attachment means is a tightenable hose clamp.

12. A grass and debris catcher bag as recited by claim 1, wherein said attachment means includes a string collapsing said inner compartment aperture.
